(19) United States
(12) Patent Application Publication
(10) Pub. No.: US 2017/0270583 A1
(43) Pub. Date: Sep. 21, 2017

(54) SYSTEM AND METHOD OF RECEIVING VEHICLE INFORMATION ON A MOBILE DEVICE

(71) Applicant: Lickedy, LLC, Indianapolis, IN (US)

(72) Inventors: Fernando Falcon, Indianapolis, IN (US); Joshua Lee, Indianapolis, IN (US)

(21) Appl. No.: 15/358,501

(22) Filed: Nov. 22, 2016

Related U.S. Application Data
(60) Provisional application No. 62/221,951, filed on Sep. 22, 2015.

(51) Int. Cl. G06Q 30/06; G06Q 10/08

(52) U.S. Cl. CPC G06Q 30/0623; G06Q 10/087

(57) ABSTRACT

Technologies for providing vehicle information by a mobile computing device in network communication with a dealer interfacing computing device include a vehicle inventory computing device configured to receive a vehicle information request from a mobile computing device, retrieve vehicle information corresponding to the vehicle information request, and transmit a response to the mobile computing device that includes the retrieved vehicle information. Additional embodiments are described herein.

### CROSS REFERENCE TO RELATED APPLICATIONS

The present application is related to, and claims the priority benefit of, U.S. Provisional Patent Application Ser. No. 62/221,951 filed Sep. 22, 2015, the contents of which are hereby incorporated in their entirety into the present disclosure.

### TECHNICAL FIELD OF THE DISCLOSED EMBODIMENTS

The presently disclosed embodiments generally relate to mobile management of vehicle information, and more particularly, to a system and method of receiving vehicle information on a mobile device.

### BACKGROUND OF THE DISCLOSED EMBODIMENTS

When shopping for a new car, a buyer generally walks on the dealer's lot to look at a few vehicles of interest. Some savvy purchasers may do their initial shopping online before heading to the dealership with a list price having already been viewed. Upon arrival at the dealership, each vehicle has a Monroney sticker affixed to the side window or windshield; however, the sticker contains the manufacturer's suggested retail price, not necessarily the dealer's listed price. To obtain or confirm the list price, the buyer has to seek the attention of a sales person, who may be busy with other potential buyers at the time. This can cause some potential buyers to become irritated with having to wait on a person to obtain a price.

Additionally, if the list price was initially outside of the potential buyer's budget, but the list price has changed due to a promotion, the potential buyer would have no way of knowing a change in the price has occurred unless the buyer went to the physical location of the dealer, or checked on-line for pricing daily. There is therefore a need for a more efficient, and timely system and method for purchasing a vehicle.

### SUMMARY OF THE DISCLOSED EMBODIMENTS

TODO

TODO

### BRIEF DESCRIPTION OF DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a block diagram of an illustrative embodiment of a system for receiving vehicle information on a mobile computing device that includes the mobile computing device, a dealer interfacing computing device, and a vehicle inventory computing device;

FIG. 2 is a block diagram of an illustrative embodiment of one of the computing devices of the system of FIG. 1;

FIG. 3 is a block diagram of an illustrative embodiment of an environment of the vehicle inventory computing device of the system of FIG. 1; and

FIG. 4 is a schematic flow diagram of an illustrative method for providing vehicle information on the mobile computing device of the system of FIG. 1.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

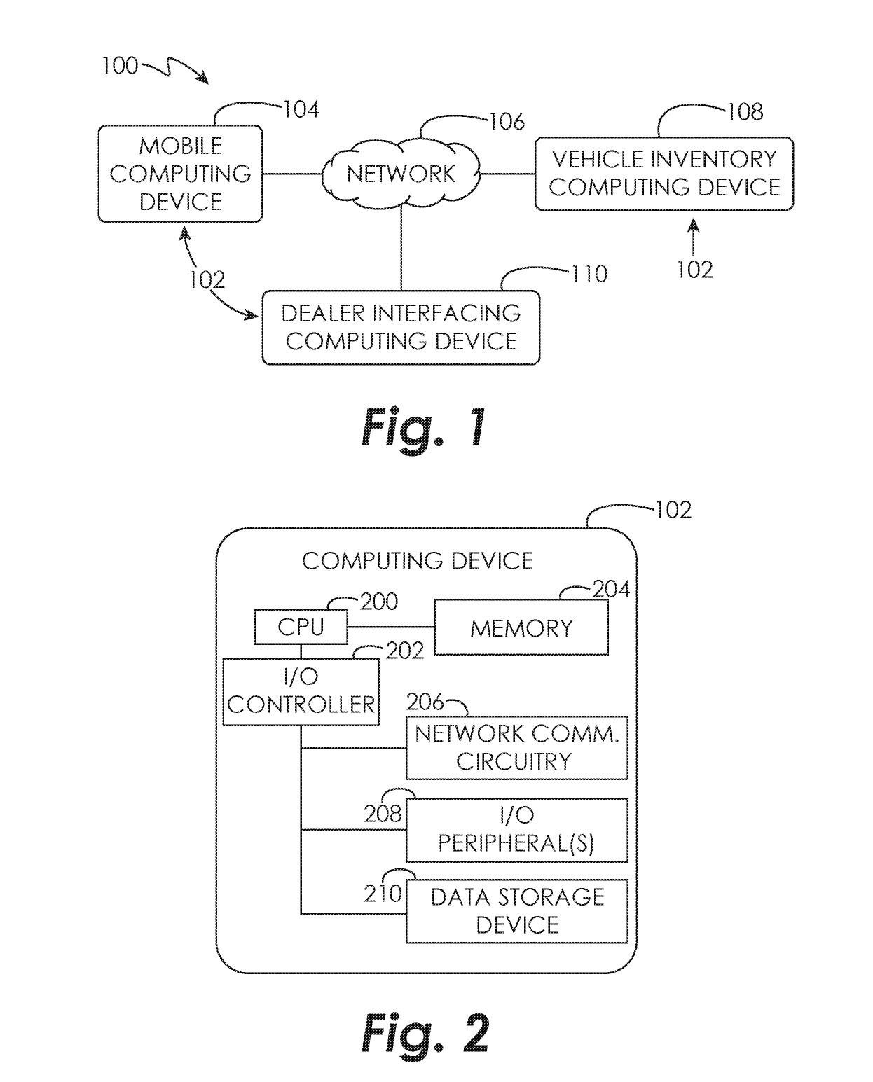

FIG. 1 illustrates a system 100 for receiving vehicle information on a mobile computing device (e.g., the mobile computing device 104). More particularly, the system 100 is configured to provide a user of the mobile computing device 104 vehicle pricing data and provide a dealer of the vehicle with information about the user, as well as results of analysis of the data, such as marketing analytics. To do so, the system 100 includes a number of computing devices 102, including the mobile computing device 104 communicatively coupled to at least one of a dealer interfacing computing device 108 and a vehicle inventory computing device 110 via a network 106.

The mobile computing device 104 is configured to transmit a message including one or more vehicle identifiers to the vehicle inventory computing device 108. Upon receiving the vehicle identifier(s), the vehicle inventory computing device 108 is configured to analyze the received information (e.g., by comparing the received vehicle identifier(s) against a known inventory of vehicles in a database), determine a matching vehicle in the dealer's inventory, and respond to the mobile computing device 104 with information related to the vehicle (i.e., vehicle information). The vehicle identifiers may include any data usable to identify a vehicle, such as a vehicle identification number (VIN), a make and model of the vehicle, etc. The vehicle information may include any data usable by a user of the mobile computing device 104 to make a buying decision, such as a price, mileage, warranty information, an accident history report, engine type, fuel type, drivetrain, transmission, year of manufacture, etc. In some embodiments, the vehicle information may additionally or alternatively include an Internet link (e.g., a uniform resource locator (URL)) usable to access the vehicle information.

In an illustrative example, a user of the mobile computing device 104 may input the vehicle identifier(s) via a graphical user interface (GUI) of an application presently executing on the mobile computing device 104, such as a messaging application, an application interfacing a cloud-based web server, or another type of application. In alternative embodiments, an application presently executing on the mobile computing device 104 may be used to capture an image (e.g., via a camera application) or otherwise scan a barcode (e.g., via a barcode scanning application). It should be appreciated that, in such barcode scanner embodiments, the barcode may be a 1-dimensional barcode (e.g., a Universal Product Code (UPC) code), a 2-dimensional bar code (e.g., a quick response (QR) code), or any other type of barcode capable of being captured and/or scanned by the mobile computing device 104.

In some embodiments, the message transmitted from the mobile computing device 104 may additionally include user identifying information. Such user identifying information may include any information usable to identify the mobile computing device 104 and/or a user thereof, such as a phone number associated with the mobile computing device 104, the name of the user associated with the mobile computing device 104, etc. It should be appreciated that the type of user identifying information may depend on the type of application from which the message was transmitted. For example, a messaging application may not include user identifying information, whereas an application designed to interface with the vehicle inventory computing device 108 may include additional information, such as may be retrieved from an account associated with the user.

Referring now to FIG. 2, an illustrative embodiment of a computing device 102 representative of one or more of the mobile computing device 104, the vehicle inventory computing device 108, and the dealer interfacing computing device 110 is shown. As shown, the illustrative computing device 102 includes a central processing unit (CPU) 200, an input/output (I/O) controller 202, a memory 204, a network communication circuitry 206, one or more I/O peripherals 208, and a data storage device 210. It should be appreciated that alternative embodiments may include additional, fewer, and/or alternative components to those of the illustrative computing device 102, such as a graphics processing unit (GPU). It should be additionally appreciated that one or more of the illustrative components may be combined on a single system-on-a-chip (SoC) on a single integrated circuit (IC).

The CPU 200 may be embodied as any type of hardware or combination of circuitry capable of processing data. Accordingly, the CPU 200 may include one or more processing cores (not shown) in a single-core processor or a multi-core processor architecture capable of reading and executing program instructions. In some embodiments, the CPU 200 may include cache memory (not shown) that may be integrated directly with the CPU 200 or placed on a separate chip with a separate interconnect to the CPU 200. It should be appreciated that, in some embodiments, pipeline logic may be used to perform software and/or hardware operations (e.g., network communication operations), rather than commands issued to/from the CPU 200.

The I/O controller 202, or I/O interface, may be embodied as any type of computer hardware or combination of circuitry capable of interfacing between input/output devices and the computing device 102. Illustratively, the I/O controller 202 is configured to receive input/output requests from the CPU 200, and send control signals to the respective input/output devices, thereby managing the data flow to/from the computing device 102.

The memory 204 may be embodied as any type of computer hardware or combination of circuitry capable of holding data and instructions for processing. Such memory 204 may be referred to as main or primary memory. It should be appreciated that, in some embodiments, one or more components may have direct access to memory, such that certain data may be stored via direct memory access (DMA) independently of the CPU 200.

The network communication circuitry 206 may be embodied as any type of computer hardware or combination of circuitry capable of managing network interfacing communications (e.g., messages, datagrams, packets, etc.) via wireless and/or wired communication modes. Accordingly, in some embodiments, the network communication circuitry 206 may include a network interface controller (NIC) capable of being configured to connect the computing device 102 to a computer network (e.g., the network 106).

The one or more I/O peripherals 208 may be embodied as any auxiliary device configured to connect to and communicate with the computing device 102. For example, the I/O peripherals 208 may include, but are not limited to, a mouse, a keyboard, a monitor, a touchscreen, a printer, a scanner, a microphone, a speaker, etc. Accordingly, it should be appreciated that some I/O devices are capable of one function (i.e., input or output), or both (i.e., input and output).

In some embodiments, the I/O peripherals 208 may be connected to the computing device 102 via a cable (e.g., a ribbon cable, a wire, a universal serial bus (USB) cable, a high-definition multimedia interface (HDMI) cable, etc.) of the computing device 102. In such embodiments, the cable is connected to a corresponding port (not shown) of the computing device 102 for which the communications made therebetween are managed by the I/O controller 202. In alternative embodiments, the I/O peripherals 208 may be connected to the computing device 102 via a wireless mode of communication (e.g., Bluetooth®, Wi-Fi®, etc.) managed by the network communication circuitry 206.

The data storage device 210 may be embodied as any type of computer hardware capable of the non-volatile storage of data (e.g., semiconductor storage media, magnetic storage media, optical storage media, etc.). Such data storage devices 210 are commonly referred to as auxiliary or secondary storage, and are typically used to store a large amount of data relative to the memory 204 described above.

It should be appreciated that the type of components of the respective computing device 102 may be predicated upon the type and intended use of the respective computing device 102. For example, referring back to FIG. 1, the mobile computing device 104 may be embodied as any type of portable computing device 102 capable of performing the functions described herein. Specifically, the mobile computing device 104 may be embodied as any type of portable computing device 102 that uses mobile-specific hardware and software components for operating, executing, and providing services and applications on a mobile architecture. Illustrative examples of such mobile computing devices 104 may include, but are not limited to, smartphones, wearables (e.g., smartwatches, smart glasses, etc.), tablets, laptops, etc. The vehicle inventory computing device 108 may be any type of computing device 102 capable of performing the functions described herein, including, but not limited to, a server, a compute device, a storage device, or a combination thereof. The dealer interfacing computing device 110 may be any type of computing device 102 capable of performing the functions described herein, including, but not limited to a desktop computer, a portable computing device, etc.

The network 106 may be implemented as any type of wired and/or wireless network, such as a local area network (LAN), a wide area network (WAN), a global network (the Internet). Accordingly, the network 106 may include one or more communicatively coupled network computing devices (not shown) for facilitating the flow and/or processing of network communication traffic via a series of wired and/or wireless interconnects. Such network computing devices may include, but are not limited, to one or more access points, routers, switches, servers, compute devices, storage devices, etc. It should be appreciated that one or more of such network computing devices may be configured to couple to one or more of the computing devices 102 of the system 100 of FIG. 1 described herein, such as via the respective network communication circuitry 206 using wired (e.g., Ethernet, token ring, etc.) and/or wireless (e.g., Bluetooth®, Wi-Fi®, wireless broadband, ZigBee®, etc.) communication technologies and associated protocols.

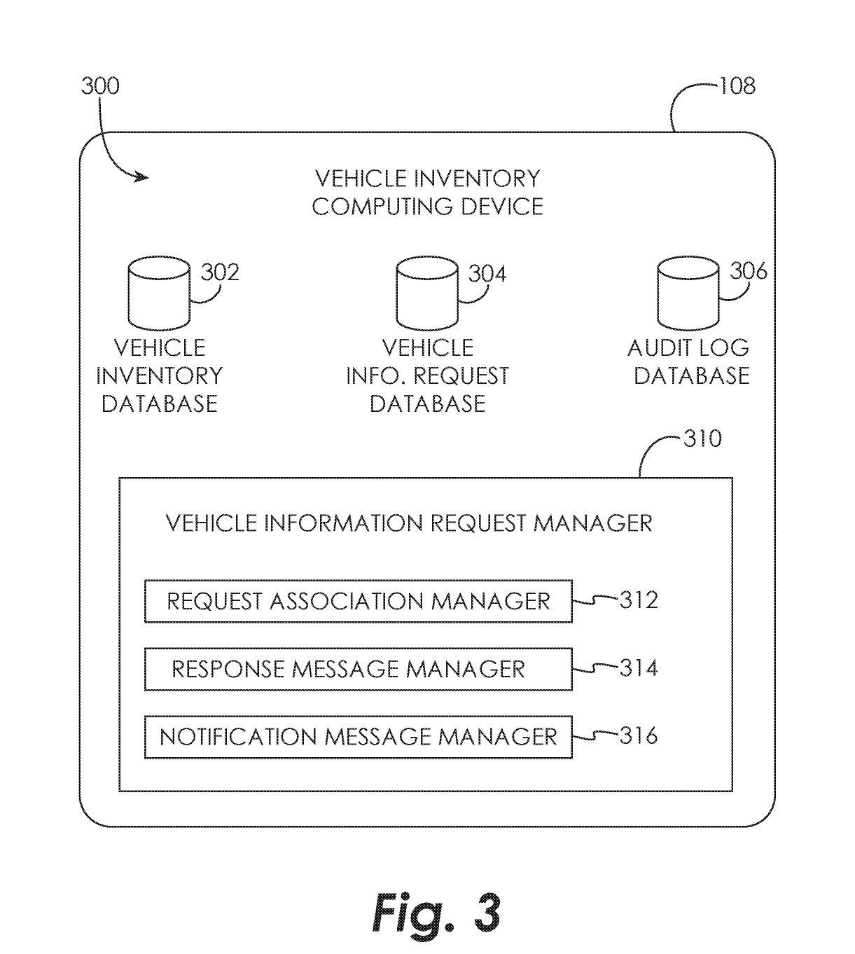

Referring now to FIG. 3, an illustrative environment 300 of a vehicle inventory computing device 108 is shown. The illustrative environment 300 includes a vehicle inventory database 302 for storing vehicle inventory data (i.e., vehicles and the data related thereto associated with a particular vehicle dealer), a vehicle information request data base 304 for storing vehicle information requests (e.g., such as may be received from a mobile computing device 104), and an audit log database 306 for storing audits of transmitted communications (e.g., such as may be sent to mobile computing devices 104 in response to having received vehicle information requests). It should be appreciated that, in some embodiments, the data stored in the respective databases may not be mutually exclusive. In other words, certain data described herein as being stored in one database may additionally or alternatively be stored in another database described herein, or another database altogether. It should be further appreciated that, in some embodiments, the data may be stored in a single database, or an alternative database arrangement.

The illustrative environment 300 additionally includes a vehicle information request manager 310 configured to manage vehicle information requests and responses related thereto. The vehicle information request manager 310 may be embodied as any combination of software, hardware, firmware, and circuitry configured to perform the functions described herein. To do so, the illustrative vehicle information request manager 310 includes a request association manager 312, a response message manager 314, and a notification message manager 316. In some embodiments, the vehicle information request manager 310 may include one or more computer-readable medium (e.g., the memory 204, the data storage device 210, and/or any other media storage device) having instructions stored thereon and one or more processors (e.g., the CPU 200) coupled with the one or more computer-readable medium and configured to execute instructions to perform the functions described herein.

The request association manager 312, which may be embodied as any type of firmware, hardware, software, circuitry, or combination thereof, is configured to receive inbound vehicle information requests from mobile computing devices 104 that include one or more vehicle identifiers. As described previously, the vehicle identifiers may include any data usable to identify a vehicle, such as a VIN, a make and model of the vehicle, etc. The request association manager 312 is further configured to analyze the received vehicle information and determine which vehicle in the dealer's inventory (e.g., such as may be stored in the vehicle inventory database 302), if applicable, is associated with the one or more vehicle identifiers. Additionally, the request association manager 312 is configured to associate the user identifying information with the vehicle associated with the vehicle information request, such that the association may be referred back to (e.g., when generating a response or follow-up message). It should be appreciated that such associative information may be stored in the vehicle request database 304.

The response message manager 314, which may be embodied as any type of firmware, hardware, software, circuitry, or combination thereof, is configured to generate a response message and transmit the response message to the mobile computing device 104 from which the vehicle information request was received. The response message may include vehicle information corresponding to the vehicle associated with the received vehicle information request. Accordingly, the response message manager 314 additionally is configured to retrieve vehicle information corresponding to the determined vehicle associated with the one or more vehicle identifiers received in the vehicle information request, such as may be determined by the request association manager 312 and retrieved from the vehicle inventory database 302.

As described previously, the retrieved vehicle information may include any data usable by a user of the mobile computing device 104 to make a buying decision, such as a price, mileage, warranty information, an accident history report, engine type, fuel type, drivetrain, transmission, year of manufacture, etc. As also described previously, in some embodiments, the vehicle information may additionally or alternatively include an Internet link (e.g., a URL) usable to access the vehicle information. It should be appreciated that the response message manager 314, in some embodiments, may be configured to generate multiple responses which may be sent subsequent to the initial response, such as follow-up messages including additional information (e.g., an updated price, an alternative vehicle, a survey, etc.).

To transmit the response message, the response message manager 314 is configured to use user identifying information, which may be included with the received vehicle information request. As described above, such user identifying information may include any information usable to identify the mobile computing device 104 and/or a user thereof, such as a phone number associated with the mobile computing device 104, the name of the user associated with the mobile computing device 104, etc. It should be appreciated that, in some embodiments, such user identifying information may be stored in the vehicle request database 304.

The notification message manager 316, which may be embodied as any type of firmware, hardware, software, circuitry, or combination thereof, is configured to generate notifications for a vehicle dealer, or more particularly for a representative (i.e., sales agent) thereof, which may be retrieved/viewed via the dealer interfacing computing device 110. In some embodiments, an application (e.g., a thin or thick client) executing on the dealer interfacing computing device 110 may push or pull such notifications for viewing at a peripheral device (e.g., a monitor) of the dealer interfacing computing device 110. Accordingly, the notification message manager 316 is further configured to transmit the notifications to the dealer interfacing computing device 110. In some embodiments, information corresponding to the transmission of messages (e.g., timestamp, telephone number associated with the mobile computing device 104, a code associated with the type of message sent, etc.) may be stored in the audit log database 306

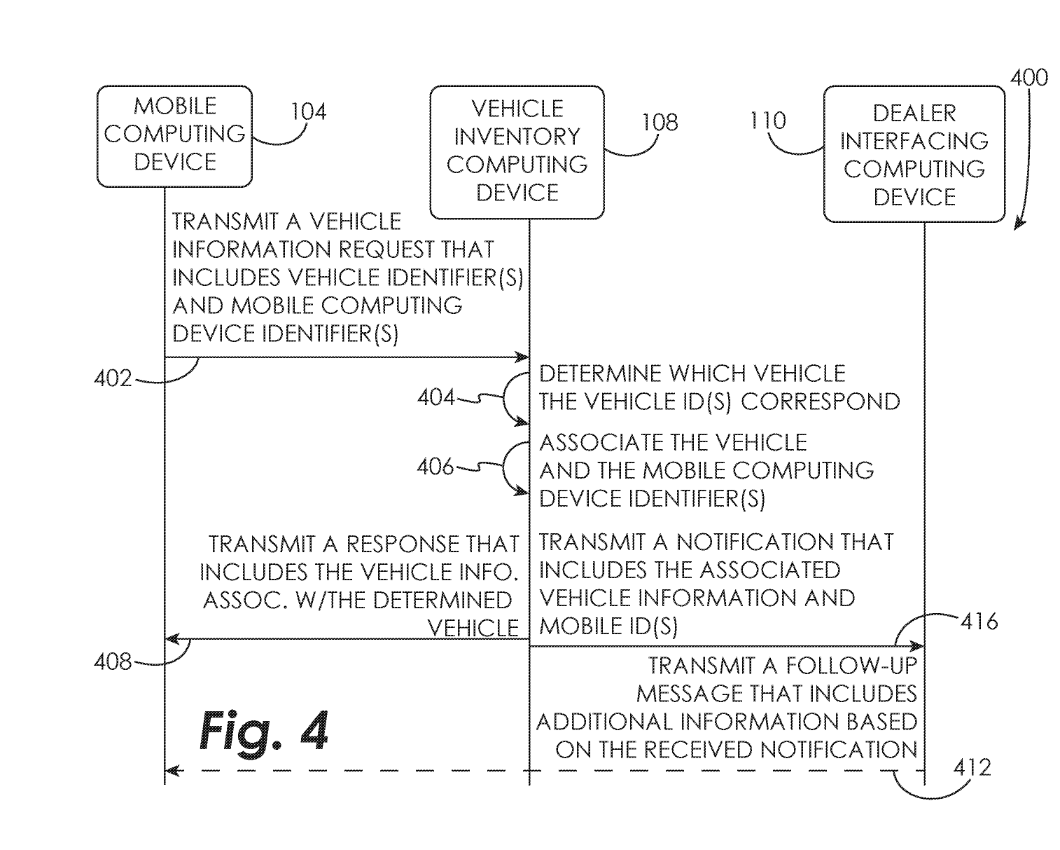

Referring now to FIG. 4, an illustrative communication flow 400 for providing vehicle information is shown. The illustrative communication flow 400 includes the mobile computing device 104, the vehicle inventory computing device 108, and the dealer interfacing computing device 110 of the system 100 of FIG. 1. The communication flow 400 begins in step 402, in which the mobile computing device 104 transmits a vehicle information request to the vehicle inventory computing device 108 that include one or more vehicle identifiers, as well as one or more identifiers of the mobile computing device 104 (i.e., user identifying information).

In an illustrative example, a potential buyer may identify one vehicle from several options while shopping for a new or used vehicle. When the buyer finds the vehicle of interest, the buyer may obtain the vehicle stock number or vehicle identification number from the window sticker (i.e. Monroney sticker) placed on the vehicle. In furtherance of the example, the buyer may then open an application (e.g., a messaging application, a dedicated dealer communication application, a barcode scanner, etc.) on the mobile computing device 104, input or capture the vehicle identifying information, and transmit the message (e.g., via a short message service (SMS) text) to a designated telephone number or URL associated with the dealer associated with that particular vehicle.

The communication flow 400 continues in step 404, in which the vehicle inventory computing device 108, upon receiving the vehicle information request, determines which vehicle the vehicle identifier(s) of the vehicle information request correspond to. In step 406, the vehicle inventory computing device 108 retrieves vehicle information associated with the vehicle determined in step 404. In step 408, the vehicle inventory computing device 108 transmits a response to the mobile computing device 104 that includes the vehicle information associated with the received vehicle identifier(s). In an illustrative example, the vehicle information may include a make, model, and list price associated with the identified vehicle, as well as any other additional vehicle information. In some embodiments, the vehicle information may additionally or alternatively include a URL corresponding to a landing page associated with the vehicle that includes such vehicle information.

In step 410, the vehicle inventory computing device 108 generates and transmits a notification of the vehicle information request to the dealer interfacing computing device 110. As such, the corresponding dealer can be alerted to any potential buyers who have expressed interest in a vehicle (i.e., receive real time updates on interest in a particular vehicle). Accordingly, the notification may include the associated vehicle information and user identifying information. The communication flow 400 continues in step 412, in which the dealer interfacing computing device 110, subsequent to having received the notification of step 410, generates and transmits a follow-up message to the mobile computing device 104. The follow-up message may include additional information based on the received notification, such as a prompt to schedule a test-drive, a promotional offer, a reduced the price on the vehicle, vehicle information pertaining to an alternative vehicle, etc.

While the present disclosure has been illustrated and described in detail in the drawings and foregoing description, the same is to be considered as illustrative and not restrictive in character, it being understood that only certain embodiments have been shown and described, and that all changes and modifications that come within the spirit of the present disclosure are desired to be protected.

What is claimed is:

1. A method for providing vehicle information, the method comprising:
receiving, by a vehicle inventory computing device, a vehicle information request from a mobile computing device, wherein the vehicle information request includes one or more vehicle identifiers;
determining, by the vehicle inventory computing device, a vehicle associated with the one or more received vehicle identifiers;
retrieving, by the vehicle inventory computing device, vehicle information associated with the determined vehicle;
transmitting, by the vehicle inventory computing device, a response to the mobile computing device, wherein the response includes the retrieved vehicle information; and
transmitting, by the vehicle inventory computing device, a notification to a dealer interfacing computing device, wherein the notification includes the vehicle information.

2. The method of claim 1, wherein determining the vehicle associated with the one or more received vehicle identifiers comprises comparing the one or more received vehicle identifiers against a database of vehicle identifiers corresponding to a respective one of a plurality of vehicles.

3. The method of claim 1, wherein the vehicle information request includes user identifying information, and further comprising associating, by the vehicle inventory computing device, the user identifying information and the determined vehicle associated with the one or more received vehicle identifiers.

4. The method of claim 3, wherein associating the user identifying information and the determined vehicle comprises associating at least one of a phone number of the mobile computing device and a name of a user of the mobile computing device with the determined vehicle.

5. The method of claim 1, wherein receiving the vehicle information request that includes the one or more vehicle identifiers includes receiving at least one of a vehicle identification number (VIN), a make of the vehicle, and model of the vehicle.

6. The method of claim 1, wherein the retrieving vehicle information includes retrieving at least one of a price of the vehicle, mileage of the vehicle, warranty information of the vehicle, an accident history report of the vehicle, an engine type of the vehicle, a fuel type of the vehicle, a drivetrain of the vehicle, a transmission of the vehicle, and a year of manufacture of the vehicle.

7. The method of claim 1, wherein receiving the vehicle information request from the mobile computing device comprises receiving a message from a web browser of the mobile computing device with instruction indicating that vehicle information has been requested.

8. The method of claim 1, wherein receiving the vehicle information request from the mobile computing device comprises receiving a message from a text messaging application of the mobile computing device.

9. A vehicle inventory computing device for providing vehicle information, the vehicle inventory computing device comprising:
one or more computer-readable medium comprising instructions;
one or more processors coupled with the one or more computer-readable medium and configured to execute the instructions to:
receive a vehicle information request from a mobile computing device, wherein the vehicle information request includes one or more vehicle identifiers;
determine a vehicle associated with the one or more received vehicle identifiers;
retrieve vehicle information associated with the determined vehicle;
transmit a response to the mobile computing device, wherein the response includes the retrieved vehicle information; and
transmit a notification to a dealer interfacing computing device, wherein the notification includes the vehicle information.

10. The vehicle inventory computing device of claim 1, wherein to determine the vehicle associated with the one or more received vehicle identifiers comprises to compare the one or more received vehicle identifiers against a database of vehicle identifiers corresponding to a respective one of a plurality of vehicles.

11. The vehicle inventory computing device of claim 1, wherein the vehicle information request includes user identifying information, and further comprising associating, by the vehicle inventory computing device, the user identifying information and the determined vehicle associated with the one or more received vehicle identifiers.

12. The vehicle inventory computing device of claim 11, wherein the user identifying information includes at least one of a phone number of the mobile computing device and a name of a user of the mobile computing device.

13. The vehicle inventory computing device of claim 1, wherein the one or more vehicle identifiers include at least one of a vehicle identification number (VIN), a make of the vehicle, and model of the vehicle.

14. The vehicle inventory computing device of claim 1, wherein the vehicle information includes at least one of a price of the vehicle, mileage of the vehicle, warranty information of the vehicle, an accident history report of the vehicle, an engine type of the vehicle, a fuel type of the vehicle, a drivetrain of the vehicle, a transmission of the vehicle, and a year of manufacture of the vehicle.

15. The vehicle inventory computing device of claim 1, wherein to receive the vehicle information request from the mobile computing device comprises to receive a message from a web browser of the mobile computing device with instruction indicating that vehicle information has been requested.

16. The vehicle inventory computing device of claim 1, wherein to receive the vehicle information request from the mobile computing device comprises to receive a message from a text messaging application of the mobile computing device.

17. A non-transitory computer-readable medium storing executable instructions on a vehicle inventory computing device, the executable instructions that cause the vehicle inventory computing device to perform the steps of:
receiving a vehicle information request from a mobile computing device, wherein the vehicle information request includes one or more vehicle identifiers;
determining a vehicle associated with the one or more received vehicle identifiers;
retrieving vehicle information associated with the determined vehicle;
transmitting a response to the mobile computing device, wherein the response includes the retrieved vehicle information; and
transmitting a notification to a dealer interfacing computing device, wherein the notification includes the vehicle information.

18. The non-transitory computer readable medium of claim 17, wherein determining the vehicle associated with the one or more received vehicle identifiers comprises comparing the one or more received vehicle identifiers against a database of vehicle identifiers corresponding to a respective one of a plurality of vehicles.

19. The non-transitory computer readable medium of claim 17, wherein the vehicle information request includes user identifying information, and further comprising associating, by the vehicle inventory computing device, the user identifying information and the determined vehicle associated with the one or more received vehicle identifiers.

20. The non-transitory computer readable medium of claim 19, wherein associating the user identifying information and the determined vehicle comprises associating at least one of a phone number of the mobile computing device and a name of a user of the mobile computing device with the determined vehicle.

21. The non-transitory computer readable medium of claim 17, wherein receiving the vehicle information request that includes the one or more vehicle identifiers includes receiving at least one of a vehicle identification number (VIN), a make of the vehicle, and model of the vehicle.

22. The non-transitory computer readable medium of claim 17, wherein the retrieving vehicle information includes retrieving at least one of a price of the vehicle, mileage of the vehicle, warranty information of the vehicle, an accident history report of the vehicle, an engine type of the vehicle, a fuel type of the vehicle, a drivetrain of the vehicle, a transmission of the vehicle, and a year of manufacture of the vehicle.

23. The non-transitory computer readable medium of claim 17, wherein receiving the vehicle information request from the mobile computing device comprises receiving a message from a web browser of the mobile computing device with instruction indicating that vehicle information has been requested.

24. The non-transitory computer readable medium of claim 17, wherein receiving the vehicle information request from the mobile computing device comprises receiving a message from a text messaging application of the mobile computing device.
